(19) United States
(12) Patent Application Publication
(10) Pub. No.: US 2015/0088942 A1
(43) Pub. Date: Mar. 26, 2015

(54) Methods and Systems for Providing File Services

(71) Applicant: Westell Technologies, Inc., Aurora, IL (US)

(72) Inventor: Anal R. Shah, Hoffman Estates, IL (US)

(73) Assignee: Westell Technologies, Inc., Aurora, IL (US)

(21) Appl. No.: 14/036,544

(22) Filed: Sep. 25, 2013

(51) Int. Cl. G06F 17/30; H04L 12/24

(52) U.S. Cl. CPC G06F 17/30194; H04L 41/50
USPC 707/827

(57) ABSTRACT

Disclosed herein are systems and methods of providing file services. According to the disclosed systems and methods, a networking device may be configured to (a) receive installation of an application that provides access to one or more file services, and (b) after receiving the installation, make the one or more file services available for access on a given client device of the one or more client devices without requiring the given client device to separately install an application that provides access to the one or more file services. In one example, the networking device may make the one or more file services available for access on the given client device by sending the given client device an instruction to dynamically update its graphical user interface (e.g., a context menu) to reflect that the one or more file services are available for access on the given client device.

### BACKGROUND

Recent trends in computing have led to the need for better information sharing between computing devices in a home network. The first of these trends is the extensive proliferation of Internet-based services that are available for consumers, including webmail, photo sharing, social networking, online auctioning, and even replacements for traditional desktop applications (e.g., word processing, spreadsheets, presentations, etc.). While there are various benefits to using Internet-based services, including low cost, ease of installation and maintenance, and portability across multiple devices, these Internet-based services also suffer from various limitations. For example, a user of an Internet-based service may be unable to access his data due to various factors, such as server unavailability, account lockout, and/or situations where an Internet-based service changes its pricing model from being a free service to a paid service. As another example, a user of an Internet-based service may encounter various privacy issues, such as lesser privacy protection under the law, weak web security systems, and/or client software that has complete access to all of the user's file system. As yet another example, a user of an Internet-based service may be subjected to data lock-in and third-party control. Many of these limitations may be overcome by storing the user's data in the home as opposed to the cloud.

The second of these trends is proliferation of post-PC computing devices in the home. Examples of these post-PC computing devices may include smart phones, smart thermostats, set-top boxes, netbooks, tablets, and digital picture frames. Many of these post-PC devices are based on closed platforms that largely inhibit interoperability. While some current file sharing protocols exist that may facilitate interoperability between these and other computing devices, including network file protocols and server-based protocols (e.g., File Transfer Protocol (FTP) or a Web-based Distributed Authoring and Versioning (WebDAV)), these current file sharing protocols have significant limitations. For instance, network file protocols require synchronization of three separate levels of security—one for each computing device and one for the network file protocol itself—which is typically not practical in a home network. Further, network file protocols that enable file sharing between computing devices based on different closed platforms may be unavailable or out-of-date depending on the relationship between the developers of those closed platforms. Further yet, server-based protocols require a user to setup and manage servers and also fail to integrate the remote files with the user's local files such that they appear as part of the user's file system.

Accordingly, a protocol that facilitates both seamless, secure sharing of resources between computing devices in a local network and seamless, secure management of resources between these computing devices and Internet-based services is desirable.

### OVERVIEW

One typical way that a user's client devices (e.g., laptop, tablet, mobile phone) may share resources with one another in a local network and/or manage resources on a remote file service is by using a software application that is specifically designed to enable the client device to seamlessly perform these functions (as opposed to just using a web browser). One representative example of such an application may take the form of an application that is specifically designed for the purpose of allowing the user to manage its files on an Internet-based media-sharing website, such as a Flickr® or YouTube® management application. Many other examples are possible as well. In order to receive the benefits of such an application, however, the user typically needs to install the application on every one of the user's client devices and then consistently maintain the application on each client device, which may involve frequent software and settings updates, etc. Moreover, in some situations, a particular application of interest may not even be available for installation on all of the user's client devices. As such, there is a need for a method and system that enables a user's client devices to access and use the functionality of these types of applications without requiring the applications to actually be installed on the user's client devices.

Disclosed herein are methods and systems that address this need. According to the disclosed methods and systems, a single networking device in a local network may be configured to host an application and enable client devices in the local network to access the functionality provided by that application (e.g., via a common protocol) without that application needing to be installed at each of the client devices. These applications may take various forms and provide the client devices with various functionality related to local and remote file services.

In a preferred example, at least one of the applications hosted by the networking device may provide the client devices with an interface between a local file service that is accessible by the client devices via the local network (e.g., a local file sharing or sync service) and a remote file service that is accessible via a remote network (e.g., Internet-based services for managing videos, photos, email, data backups, social media, and the like), such that the client devices may access the application's functionality for managing resources on the remote file service without the client devices actually installing the application. According to this example, the client devices may advantageously be able to seamlessly access and manage resources on the remote file service without having to install or manage its own copy of an application for performing these functions.

One embodiment may take the form of a method including (a) in a networking device coupled to one or more client devices in a local network, hosting an application that provides an interface between a first file service accessible via the local network and a second file service accessible via a remote network, (b) the networking device making the first file service available for access on a given client device of the one or more client devices via the local network, (c) the networking device receiving, from the given client device, a message that indicates a change in a relationship between a given resource stored on the given client device and the first file service, (d) after receiving the message, the networking device determining that the change in the relationship between the given resource and the first file service requires a change to the second file service, (e) in response to the determining, the networking device defining a message that requests the change to the second file service, and (f) the networking device sending the message to the remote network. This method may be embodied as program instructions on a non-transitory computer readable medium.

The first file service may comprise, for example, one or more of a file share service, a file sync service, and a file search service. The second file service may comprise, for example, a media-hosting web service accessible via the remote network (e.g., the Internet). Other examples of either file service are also possible.

The message that requests the change to the second file service may take various forms. In one example, the message may be a message that requests an addition of the given resource to the second file service. In another example, the message may be a message that requests a removal of the given resource from the second file service. In yet another example, the message may be a message that requests an update to the given resource in the second file service. Other examples are possible as well.

Another embodiment may take the form of a method including (a) in a networking device coupled to one or more client devices in a local network, receiving installation of an application that provides a given file service accessible via the local network, and (b) in response to receiving the installation, the networking device making the given file service available for access on a given client device of the one or more client devices via the local network, wherein making the given file service available for access on the given client device includes sending the given client device an instruction to dynamically update its graphical user interface to reflect that the given file service is available for access on the given client device.

Additionally, this method may include (c) the networking device receiving an instruction to update a status of the application, wherein the update to the status of the application comprises one of: an enabling of the application, a disabling of the application, and an uninstallation of the application from the networking device, and (d) in response to receiving the instruction, the networking device providing instructions to the given client device to dynamically update the graphical user interface of the given client device to reflect the updated status of the application. This method may be embodied as program instructions on a non-transitory computer readable medium.

Yet another embodiment may take the form of a networking device that includes (a) a communication interface configured to interface with one or more client devices in a local network and further configured to interface with a remote network, and (b) a processor configured to enable the networking device to (1) host an application that provides an interface between a first file service accessible via the local network and a second file service accessible via the remote network, (2) make the first file service available for access on a given client device of the one or more client devices via the local network, (3) receive, from the given client device, a message that indicates a change in a relationship between a given resource stored on the given client device and the first file service, (4) determine, after receiving the message, that the change in the relationship between the given resource and the first file service requires a change to the second file service, (5) define, in response to the determining, a message that requests the change to the second file service, and (6) send the message to the remote network.

These as well as other aspects and advantages will become apparent to those of ordinary skill in the art by reading the following detailed description, with reference where appropriate to the accompanying drawings.

### BRIEF DESCRIPTION OF THE DRAWINGS

FIG. 1 is a simplified diagram of an example communication system in which an example protocol can be implemented;

FIG. 2 is a simplified block diagram of components installed on the networking device and each of the client devices in the system of FIG. 1, according to an embodiment;

FIG. 3 is a simplified block diagram showing components of an access manager installed on the networking device in the system of FIG. 1, according to an example embodiment;

FIG. 4 is a simplified block diagram showing components of a storage manager installed on the networking device in the system of FIG. 1, according to an example embodiment;

FIG. 5 is a flow chart depicting an example method of providing a local file service accessible on a given client device via a local network and managing access to the local file service;

FIGS. 6 and 7 are example client device user interfaces depicting the local file service being made available on the given client device;

FIGS. 8-12 are an example Internet-based user interface that comprises one or more webpages associated with installing and managing applications on the networking device, in accordance with the example protocol;

FIG. 13 is a flow chart depicting an example method of providing the local file service in conjunction with a remote file service so as to enable computing devices in the local network to share/sync/search resources with computing devices in a remote network;

FIGS. 14 and 15 are example client device user interfaces showing steps to change a relationship between a given resource and the local file service; and

FIG. 16 is a flow chart depicting an example method of facilitating access to a given resource associated with the local file service.

### DETAILED DESCRIPTION

### I. Example Communication System

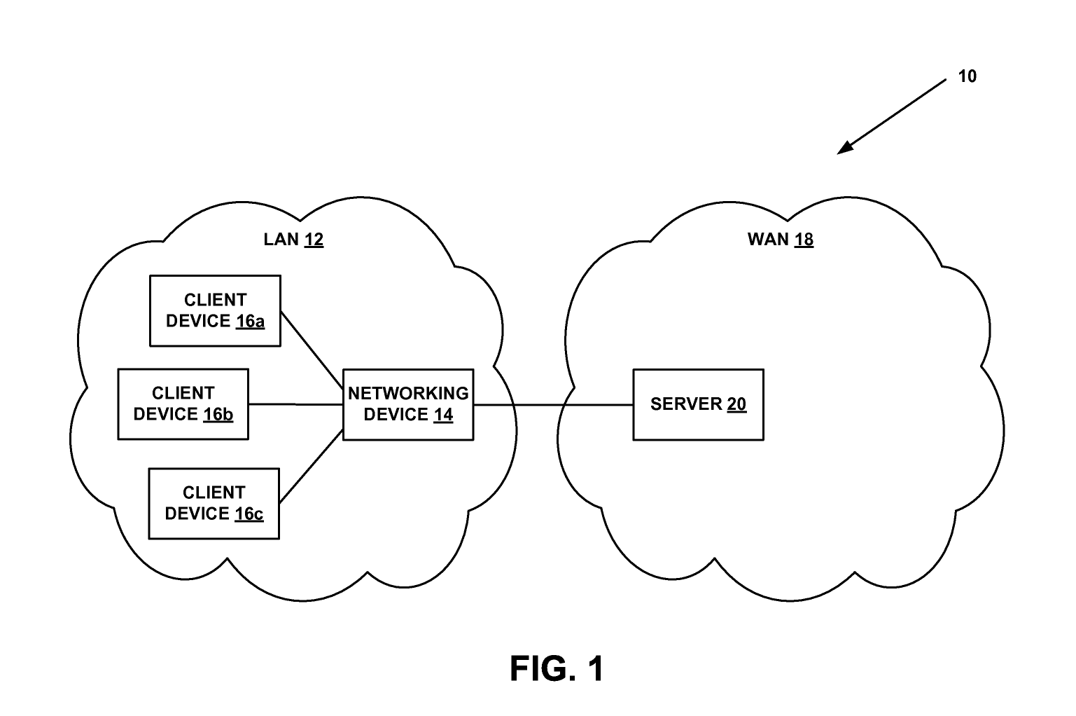

Referring to the drawings, FIG. 1 is a simplified block diagram of an example communication system 10 in which embodiments of the disclosed protocol and associated methods and entities can be implemented. It should be understood that the arrangements described herein are set forth for purposes of example only. As such, those skilled in the art will appreciate that other arrangements and other elements (e.g., machines, interfaces, functions, orders of functions, etc.) can be used instead, some elements may be added, and some elements may be omitted altogether. Further, as in most telecommunications applications, those skilled in the art will appreciate that many of the elements described herein are functional entities that may be implemented as discrete or distributed components or in conjunction with other components, and in any suitable combination and location. Still further, various functions described herein as being performed by one or more entities may be carried out by hardware, firmware and/or software. For instance, various functions may be carried out by a processor executing a set of machine language instructions written in any suitable programming language (e.g., C, C++, Java, etc.) and stored in memory.

As shown, system 10 may include a representative local network, such as a local area network (LAN) 12 (e.g., a home network), in which a representative networking device 14 is coupled to one or more representative local client devices 16a-c. Further, as shown, system 10 may include a representative remote network, such as wide area network (WAN) 18 (e.g., the Internet), that provides connectivity between LAN 12 and one or more remote devices, such as a server 20. Various other configurations of system 10 are possible as well.

Networking device 14 may be any computing device configured to (1) interconnect each of client devices 16a-c, (2) interconnect LAN 12 with WAN 18 (or another type of remote network), and (3) carry out aspects of the example protocol described herein. In this respect, networking device 14 may take various forms, including as examples a switch, a bridge, a router, and/or a gateway. Regardless of the specific form, networking device 14 may include various hardware components (e.g., a processor, data storage, a LAN communication interface, and a WAN communication interface) and software components (e.g., applications and/or other program logic/data) that enable networking device 14 to carry out aspects of the methods disclosed herein. Additionally, networking device 14 may also include stored resources (e.g., directories and/or files with associated metadata). Other configurations of network device 14 are possible as well.

Each of local client devices 16a-c may be any computing device configured to carry out aspects of the example protocol described herein. In this respect, each of local client devices 16a-c may take various forms, including as examples a desktop computer, a laptop, a netbook, a tablet, a smart phone, a personal digital assistant (PDA), a set-top box, or a network-attached storage (NAS) device. Further, each of local client devices 16a-c may employ various operating systems (e.g., Windows, Mac OS, Linux, iOS, Andriod, etc.) and host various application software. Regardless of the specific form, each of local client devices 16a-c may include various hardware components (e.g., a processor, data storage, a communication interface, perhaps a user interface, etc.) and software components (e.g., program logic and program data) that enable the local client device to carry out aspects of the methods disclosed herein. Additionally, each of local client devices 16a-c may include stored resources (e.g., directories and/or files with associated metadata). Other configurations of client devices 16a-c are possible as well.

As shown, each of local client devices 16a-c may be coupled to networking device 14 via a respective communication path. These paths may take various forms. For instance, some or all of these paths may include a wired link, such as twisted-pair copper cable, coaxial cable, and/or optical fiber cable for instance. Further, some or all of these paths may include a wireless link, such as Wi-Fi link for instance. Further yet, some or all of these paths may include an intermediate networking and/or computing device. These paths may take other forms as well.

The representative remote network, such as WAN 18, may be any collection of networks, computing devices, protocols, etc. that span regions, countries, or the world. For example, as noted above, WAN 18 may be the Internet and may be accessible by one or more client devices and networking devices throughout the world, in accordance with varying protocols.

Server 20 may be any computing device (or devices) in WAN 18 configured to host the remote file service and carry out the remote file service, such as by storing data, providing a web interface, and the like. In this respect, server 20 may take various forms, including as examples a database server, a file server, a web server, an application server, or the like. Regardless of the specific form, server 20 may include various hardware components (e.g., a processor, data storage, a LAN communication interface, and a WAN communication interface) and software components (e.g., applications and/or other program logic/data) that enable server 20 to carry out aspects of the disclosed protocol. Additionally, server 20 may also include stored resources (e.g., directories and/or files with associated metadata). Other configurations of server 20 are possible as well.

### II. Example Protocol

Disclosed herein is an example protocol that enables both seamless, secure information sharing between client devices in a local network and seamless, secure management of resources between these client devices and file services that are accessible via a remote network. According to the disclosed protocol, a networking device in a local network may be configured to host applications in a manner that enables one or more local client devices in the local network to access and use the features of the applications without requiring the applications to be installed on the client devices. For instance, these applications may provide local file services that are accessible via the local network. Further, at least some of these applications may provide an interface between a respective local file service accessible via the local network and a respective remote file service accessible via a remote network, such that a client device in the local network can access the remote file service (via the local file service and the networking device) without having to install a separate application for doing so.

In practice, the local file service(s) are provided by the networking device and enable client devices in the local network to seamlessly share, synchronize, and access resources (e.g., files and directories) within the local network. These local file service(s) may take various forms. In one example, a local file service may take the form of a file share service that enables a client device in the local network to make stored resources available for access by other client devices in the local network and correspondingly enables the other client devices (and/or the networking device) to access the available resources. In another example, a local file service may take the form of a file sync service that enables a group of client devices in the local network to make stored resources available for synchronization with one another and correspondingly enables other client devices in the local network (and/or the networking device) to access the synchronized resources. In yet another example, a local file service may take the form of a file search service that enables a client device in the local network to make stored resources available for search by other client devices in the local network and correspondingly enables the other client devices in the local network to conduct searches on the available resources based on metadata (e.g., file name, file type, etc.). Other examples are possible as well.

In practice, the networking device may provide access to the local file services in various manners. For example, the networking device may send an instruction to a respective client device for the respective client device to update its context menu to include a means for accessing one or more local file service. Namely, the context menu may be updated to list one or more local file services to which one or more given resources stored on the respective client device can be assigned. The networking device may implement this via a file context menu service configured to provide the context menu. The file context menu service may provide this context menu in various manners. For instance, the file context menu service may first obtain the list of available local file services. In turn, the file context menu service may display local file service options on a given resource's general context menu, which may be accessible by right-clicking on the given resource. Other methods of the networking device providing a local file service to the client devices are possible as well, such as via other interface elements (e.g., tray icon, other menus).

In turn, the remote file service(s) are hosted by devices on the remote network and enable computing devices in the local network (e.g., client devices) to store and access resources on these remote devices. These remote file service(s) may also take various forms. In one example, a remote file service may take the form of a photo sharing service accessible via the Internet, such as Flickr®, which may enable a user to upload to the photo sharing service photo files stored on their client device and then manage those photo files. In another example, a remote file service may take the form of a video sharing service accessible via the Internet, such as YouTube®, which may enable a user to upload to the video sharing service video files stored on their client device and then manage those video files. Other media-based remote file services are possible as well, and non-media types of remote file services are also possible.

As noted above, a client device can access these remote file services using applications installed on the client device. As further noted above, the networking device configured according to the disclosed protocol may provide an interface between a local file service and a remote file service, which enables a client device configured according to the protocol to access the remote file service without requiring the client device to install such an application locally at the client device. This access may take various forms.

As one example, if a user of a client device wishes to upload a given resource on the client device to a remote file service, the user may simply request that the given resource on the client device be added (or “assigned”) to a local file service that is associated with the remote file service, which causes the client device to send a message to the networking device indicating this assignment. In turn, the networking device may receive the message from the given client device, determine that the given resource has been assigned to the local file service that is associated with the remote file service, and then cause the given resource to be uploaded to the remote file service without any further interaction by the user.

As another example, if a user of a client device wishes to delete a given resource on the client device that was previously assigned to a local file service and uploaded to a remote file service, the user may simply request that the given resource be removed from the local file service, which causes the client device to send a message to the networking device indicating this removal. In turn, the networking device may receive the message from the client device, determine that the given resource has been removed from the local file service that is associated with the remote file service, and then cause the given resource to be deleted from the remote file service without any further interaction by the user.

As yet another example, if a user of a client device wishes to update (e.g., modify) a given resource on the client device that was previously assigned to a local file service and uploaded to a remote file service, the user may simply update the given resource, which causes the client device to send a message to the networking device indicating this update. In turn, the networking device may receive the message from the client device, determine that the given resource has been updated, and then cause the given resource to be updated on the remote file service without any further interaction by the user.

The aspects of the example protocol may be carried out by various software components that run on the networking device and the client device(s) in the local network. These software components may each take the form of program instructions and associated data of various forms (e.g., object code, machine language code, bytecode, and/or source code) that are executable or interpretable by a processor to carry out aspects of the example protocol. Further, some of these software components may take the form of application software that is installed onto the networking device and/or the client device(s). In an embodiment, these software components may include one or more APIs designed according to representational state transfer (REST) guidelines. The software components may take other forms as well.

### a. Example Software Components

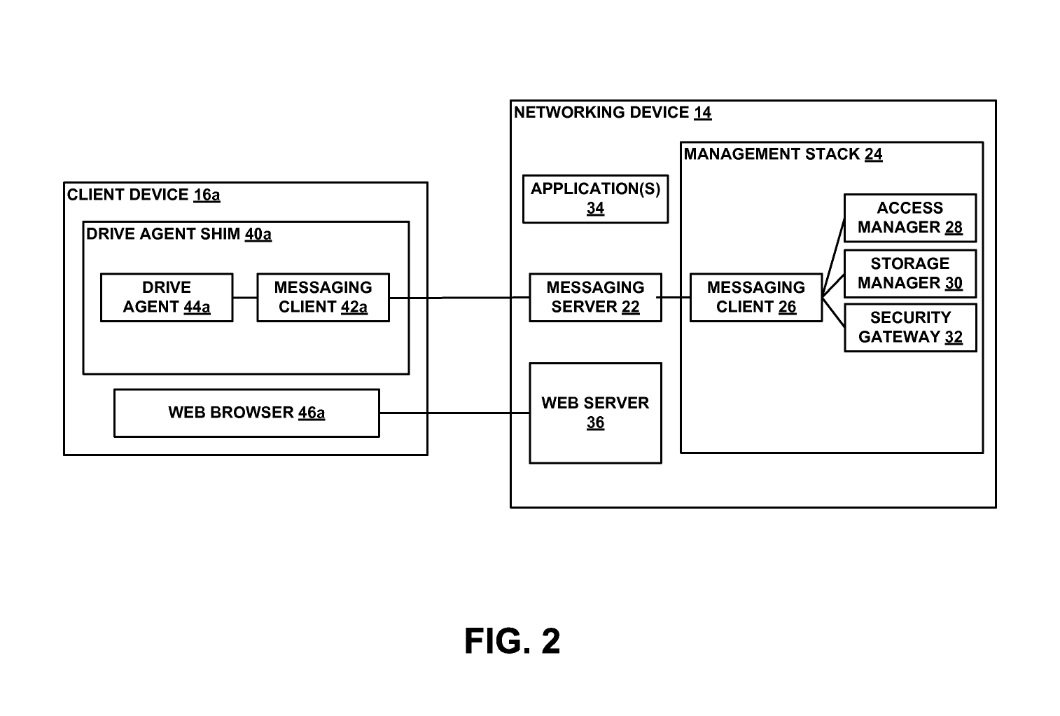

FIG. 2 is a simplified block diagram of software components configured to carry out features of the example protocol, according to an example embodiment. For purposes of illustration, the software components are depicted as being installed on networking device 14 and representative client device 16a, although it should be understood that similar components can be installed on each of the other client devices as well. It should also be understood that the software components and associated functions described herein may be installed and/or stored on various other devices and may take various forms (e.g., object code, machine language code, bytecode, and/or source code).

As shown in FIG. 2, networking device 14 may have installed thereon a messaging server 22 and a management stack 24 that includes a messaging client 26, an access manager 28, a storage manager 30, and a security gateway 32. Further, networking device 14 may have installed thereon one or more applications 34 and a web server 36. Many other configurations are possible as well. For example, although not shown, networking device 14 may also have installed thereon a drive agent shim.

Further, as shown, client device 16a may have installed thereon a drive agent shim 40a that includes a respective messaging client 42a, a drive agent 44a, and a web browser 46a. Other configurations are possible as well.

Messaging server 22 may be configured to facilitate low-level communication between the computing devices and/or components of LAN 12. In this respect, messaging server 22 may communicate with messaging client 26 and messaging client 42a according to various communication protocols. As one example, messaging server 22 may communicate with messaging client 26 and messaging client 42a according to the Extensible Messaging and Presence Protocol (XMPP), which is an open, Extensible Markup Language (XML)-based protocol. According to XMPP, messaging client 26 and messaging client 42a may establish a long-running Transmission Control Protocol (TCP) connection with Transport Layer Security (TLS) to messaging server 22. In turn, messaging client 26 and messaging client 42a may open an XML document called a “stanza” for the lifetime of the established TCP connection and then append individual messages to the stanza, which may allow messaging client 26 and messaging client 42a to send messages to messaging server 22 without the burden of opening and closing TCP connections. As such, according to XMPP, multiple higher-level operations can occur simultaneously over one TCP connection. Messaging server 22 may communicate with messaging client 26 and messaging client 42a according to other communication protocols as well.

According to an embodiment, messaging client 26 and messaging client 42a may be configured to have one dedicated messaging account for use when communicating according to the example protocol. Messaging client 26 and messaging client 42a may then be configured to filter received messages according to its dedicated account identifier (e.g., a JabberlD in XMPP) and then route the received messages to other software components as appropriate. Correspondingly, a component installed on networking device 14 (e.g., access manager 28) may be configured to contain a mapping of messaging client devices to messaging account identifiers.

Messaging server 22 may provision a messaging account with one of messaging client 26 and messaging client 42a (and messaging clients of client devices 16b-c, in other embodiments) in various manners. For instance, drive agent shim 40a on client device 16a may first perform an auto-discovery operation to locate messaging server 22 (e.g., via a DNS-DS mechanism) and may then initiate an auto-registration process by providing messaging server 22 with a device name and a registration identifier. Drive agent shim 40a may also display the registration identifier to a user of client device 16a. Thereafter, the user may access a management interface provided by a component installed on networking device 14 to request addition of drive agent shim 40a to LAN 12. For example, while accessing the interface, the user may select drive agent shim 40a and then enter its registration identifier. In turn, the component on networking device 14 may validate the entered registration identifier against the registration identifier received from drive agent shim 40a during the auto registration process. If valid, the component on networking device 14 may generate a messaging account for drive agent shim 40a and then send a password for the account to drive agent shim 40a, which may in turn store the password for future use in establishing connections with messaging server 22. Other examples of messaging account provisioning methods may exist as well.

Messaging server 22 may also be configured to facilitate communication between networking device 14 and components/devices of WAN 18 (or other type of remote network), such as server 20, via standard Internet-based communication techniques such as an API. As such, messaging server 22 may provision a messaging account with a messaging server (and/or messaging client) component of WAN 18, and may implement provisioning methods similar to those described above in order for networking device 14 to register with WAN 18.

Access manager 28 may be configured to control access to the file services provided by networking device 14 in LAN 12 according to the disclosed protocol. In this respect, access manager 28 may include various components that enable it to perform the functions described herein.

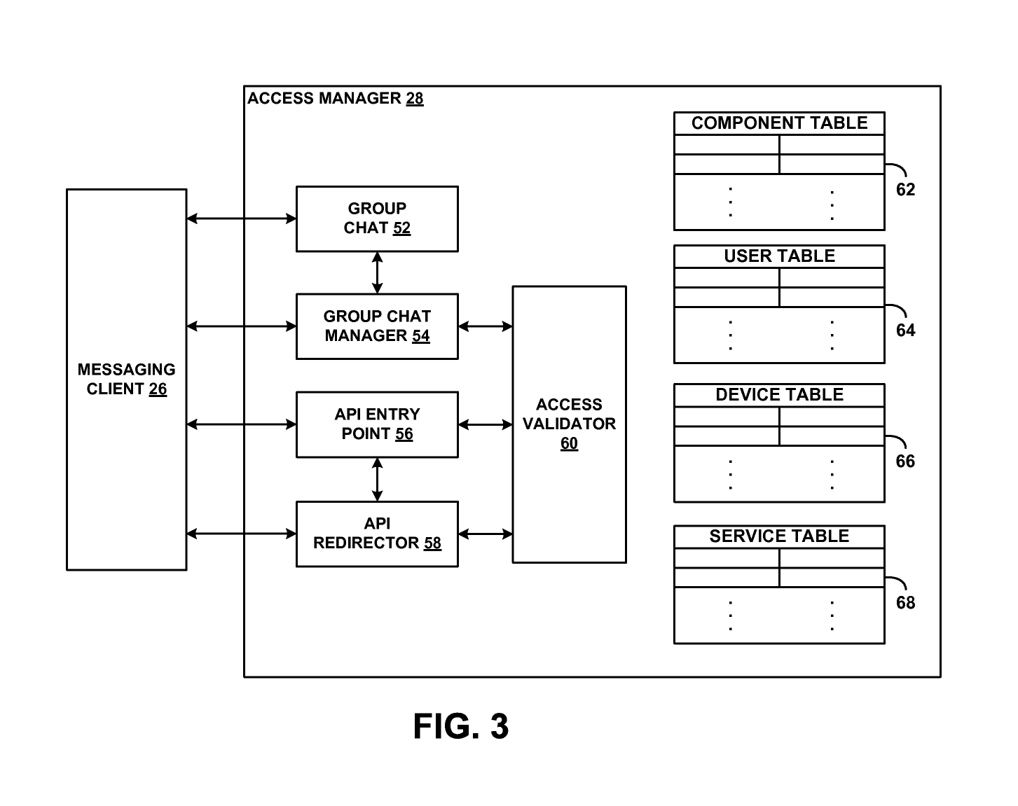

FIG. 3 is a simplified block diagram showing components of access manager 28, according to an example embodiment. As shown, access manager 28 may include a group chat component 52, a group chat manager 54, an API entry point 56, an API redirector 58, an access validator 60, a component table 62, a user table 64, a device table 66, and a service table 68. Other configurations of access manager 28 are possible as well.

Group chat component 52 may be configured to facilitate a chat room and thereby enable devices and/or components in LAN 12 to share status information (e.g., presence announcements). In one example, access manager 28 may create group chat component 52 on startup, after which time access manager 28 may receive requests to join the chat room from various components. Correspondingly, group chat manager 54 may be configured to manage access to group chat component 52.

API entry point 56 may be configured as the initial destination of all API requests. Correspondingly, API redirector may 58 be configured to forward API request to the proper device(s) and/or component(s) of LAN 12 and access validator 60 may be configured to validate API requests against access privileges.

Component table 62 may be configured to contain a list of protocol components in LAN 12 (e.g., drive agent shim 40a, and/or other drive agent shims). Additionally, component table 62 may be configured to contain a mapping between identifiers of software components in LAN 12 and corresponding messaging account identifiers (e.g., JabberIDs in XMPP). Additionally yet, component table 62 may be configured to contain current status information for the components in LAN 12, such as whether a component is online or offline. Such information may be obtained via chat room component 52. Other examples are possible as well.

User table 64 may be configured to contain a list of users of the disclosed protocol in LAN 12. Further, user table 64 may be configured to contain a mapping between identifiers of protocol users in LAN 12 and identifiers of devices and/or components in LAN 12 associated with each user. Other examples are possible as well.

Device table 66 may be configured to contain a list of protocol devices in LAN 12 (e.g., client devices 16a-c). Additionally, device table 66 may be configured to contain current status information for the protocol devices in LAN 12, such as whether a device is online or offline. Other examples are possible as well.

Service table 68 may be configured to contain a list of available local file services provided by the example protocol in LAN 12. Additionally, service table 68 may be configured to contain a mapping between each available file service and a list of users allowed to access that file service. In this respect, the list of users allowed to access a new file service may initially include only the creating user of that file service, and the creating user and/or an administrator may then update the list of users allowed to access the file service via a management interface. Other examples are possible as well.

Referring back to FIG. 2, storage manager 30 may be configured to manage the file services provided by the disclosed protocol in LAN 12. In this respect, storage manager 30 may include various components that enable it to perform the functions described herein.

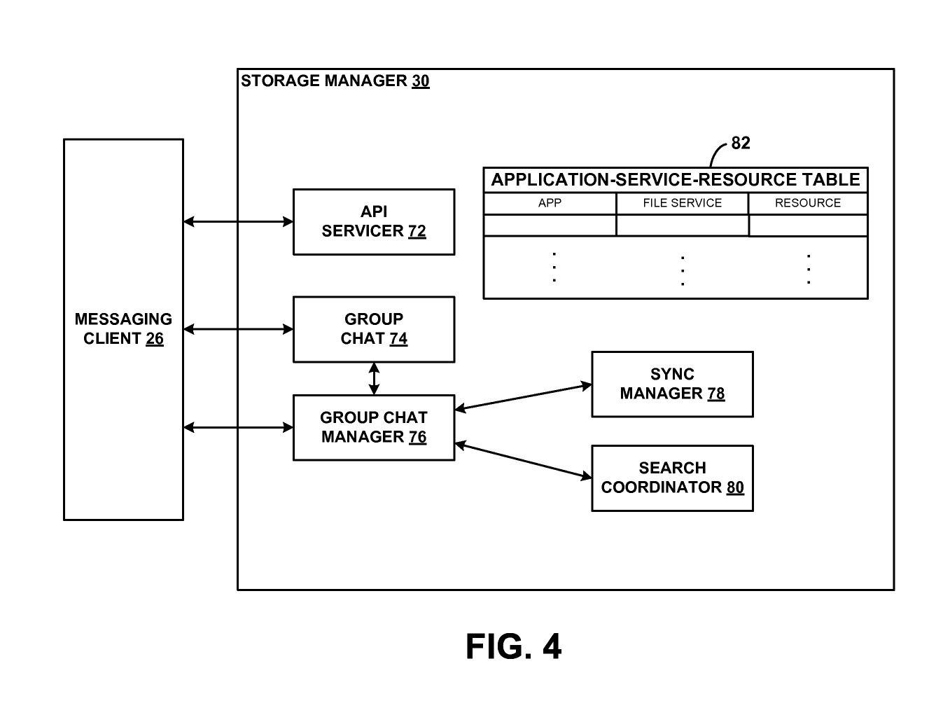

FIG. 4 is a simplified block diagram showing components of storage manager 30, according to an example embodiment. As shown, storage manager 30 may include an API servicer 72, a group chat component 74, a group chat manager 76, a sync manager 78, a search manager 80, and a service-resource table 82. Other configurations of storage manager 30 are possible as well.

API servicer 72 may be configured to respond to API requests. For example, API servicer 72 may receive an API call and identify a component (e.g., drive agent shim 40a) to service the API call. Other examples are possible as well.

Group chat component 74 may be configured to facilitate a chat room and thereby enable devices and/or components in LAN 12 to report status and change information regarding resources in LAN 12. Correspondingly, group chat manager 76 may be configured to manage access to group chat component 74.

Sync manager 78 may be configured to monitor the chat room for status information relating to file sync services, such as announcements regarding changes to resources. Additionally, sync manager 78 may be configured to initiate sync sessions between components in LAN 12 participating in file sync services, such that all resources assigned to a file sync service remain synchronized.

Search manager 80 may be configured to coordinate search operations relating to any file search services.

Application-service-resource table 82 may be configured to contain a mapping between each application 34 hosted by networking device 14, the respective local file service provided by networking device 14 according to the disclosed protocol that is associated with the application, and a list of resources assigned to the respective local file service. In this respect, application-service-resource table 82 may contain (1) an identifier of the application, (2) an identifier of the respective local file service, (3) a unique resource identifier of each stored resource assigned to the respective local file service, and/or (4) an identifier of a device and/or component on which each resource is stored. Additionally, application-service-resource table 82 may be configured to contain status information for each resource assigned to the respective local file service, such as whether a resource is available or unavailable. The status information may also include whether a relationship between a resource and a remote file service has been changed, the remote file service being associated with the respective local file service that the resource is assigned to. Other examples are possible as well. Further, networking device 14 may also include as either part of application-service-resource table 82 or as a separate table, status information for each application, such as a listing for each application of all associations between the local file service(s) and the remote file service(s).

In some examples, when a particular application is installed on networking device 14, columns or other means of maintaining the particular application's data may be added to application-service-resource table 82 so that the table can maintain data associated with the particular application. Likewise, when that particular application is uninstalled on networking device 14, those columns or other means of maintaining that particular application's data may be deleted from application-service-resource table 82. Still further, when a particular application is installed on networking device 14 but is disabled by a user, application-service-resource table 82 may continue to maintain the particular application's data, though access to that data may not be possible until the particular application is enabled by the user. Other examples are also possible.

In some embodiments, networking device 14 may also include a local data storage (e.g., a database) (not shown) that is included as part of storage manager 30 or as a separate component (in which case storage manager 30 may be configured to interface with the local data storage). In these embodiments, networking device 14 may then be configured to maintain at least one copy of certain resources that have been assigned to the local file services by storing those copies in the local data storage, application-service-resource table 82, and/or at another storage location.

Referring back to FIG. 2, security gateway 32 may be configured to facilitate secure access of resources stored on devices in LAN 12 by other devices via WAN 18. Security gateway may perform this function in any manner now know or later developed.

Application(s) 34 are software (i.e., program instructions) stored in data storage of networking device 14 that, when executed, can cause networking device 14 to perform functions in accordance with the disclosed protocol. A given application may be associated with a given local file service and a given remote file service, and may provide an interface (e.g., a web interface) between the given local file service and the given remote file service. In practice, a given application may be developed by someone that has access to a remote file service's API (e.g., access to Flickr® API, YouTube® API, etc.), and may be provided to networking device 14 to be downloaded and installed at networking device 14. Further in some embodiments, a given application of the one or more applications 34 may support multiple local file services and/or a given local file service may be associated with multiple applications.

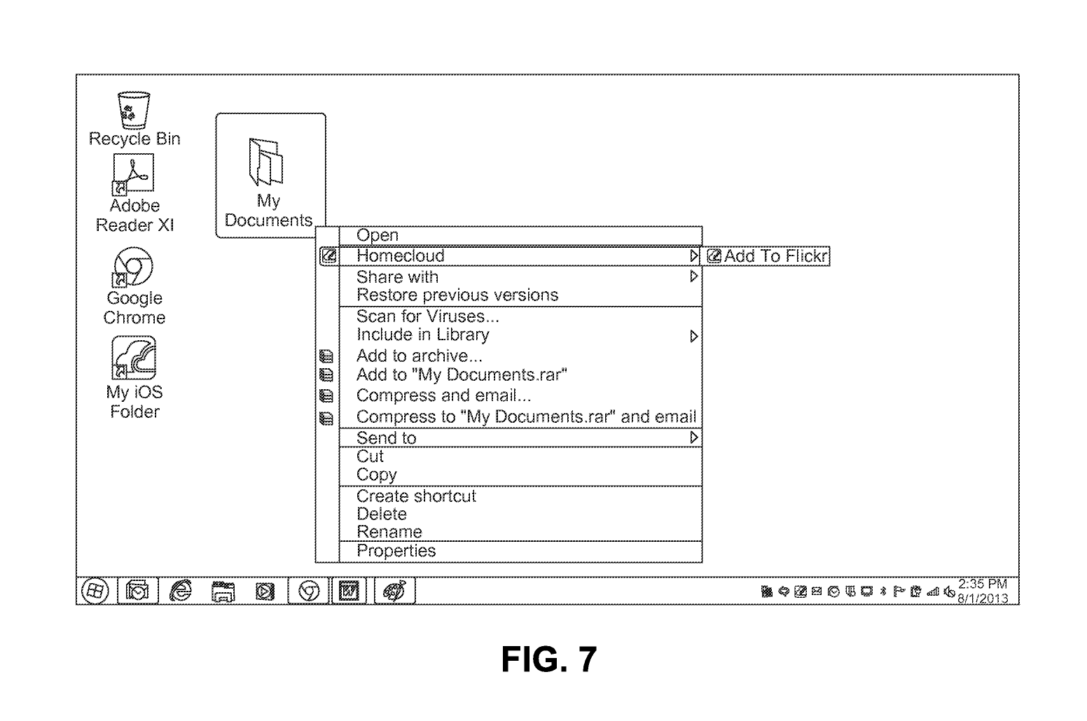

Web server 36 may be configured to host websites, such as a web interface for managing applications hosted by networking device 14. The web interface may take the form of a user interface that is accessible by a user of client device 16a (via web browser 46a) and can be used to install/uninstall a given application on networking device 14, view the applications currently installed on networking device 14, and view various settings and information associated with the applications, such as a status of a given application (e.g., enabled, disabled, etc.), one or more local file services associated with a given application, and a history of messages associated with the given application, among other possibilities. As one possible example, the web interface may take the form of the web interface shown in FIGS. 7-11, or may take other forms not described herein.

Web browser 46a on representative client device 16a may enable a user of representative client device 16a to access the web interface hosted by web server 34 in order to manage applications on networking device 14.

Drive agent 44a (and/or other drive agents of other client devices in LAN 12) may be configured to enable its hosting client device to participate in the local file services provide by the example protocol. For example, drive agent 44a may receive and fulfill requests from users to assign stored resources to a local file service. As another example, drive agent 44a may receive and fulfill requests from native applications on a hosting client device to access a resource stored on another client device (or networking device 14). As yet another example, drive agent 44a may receive and fulfill requests from storage manager 30 to provide a resource stored on a hosting client device to another client device (or networking device 14). Other examples are possible as well.

Drive agent 44a may also include or have access to various other components that perform functions related to the file services provided by the example protocol. For instance, drive agent 44a may include or have access to a file system monitor configured to monitor and report changes to resources in the hosting client device's file system. As one example, drive agent 44a may monitor resource changes using a file filtering service provided by the hosting client device's operating system. Correspondingly, drive agent 44a may track and record resource changes using a transaction log and/or a hash tree (e.g., a Merkle tree). Other examples are possible as well.

Further, drive agent 44a may include or have access to a resource badge updater configured to manage badges for stored resources assigned to file services. These resource badges may take the form of a small graphic that is overlaid on the resource icon and displayed through the hosting client device's file browser to indicate whether the resource is up-to-date or out-of-date. In some embodiments, these resource badges may be written to the resource's metadata. Other examples are possible as well.

Further yet, drive agent 44a may include or have access to a file context menu service configured to provide, for one or more resources on client device 16a, a context menu that lists the local file services to which the resource can be assigned. The file context menu service may provide this context menu in various manners. For example, the file context menu service may first obtain the list of available local file services from service table 68 of access manager 28. As another example, networking device 14 may send client device 16a an instruction to update the list of available file services. In turn, the file context menu service may display local file service options on a resource's general context menu, which may be accessible by right-clicking on the resource.

In other embodiments, drive agent 44a may provide other interface elements such as tray icons on a taskbar additionally or alternatively to providing a context menu. For example, when an application is installed at networking device 14, networking device 14 may send an instruction to update the taskbar to include a tray icon associated with the application. Local file service options associated with the application may then be accessible by clicking on the tray icon. Further, clicking on the tray icon may cause a window or menu to appear in which relationships between given resources and corresponding local file services can be managed. Other examples are possible as well.

Still further, drive agent 44a may include or have access to a resource-location table configured to contain a mapping between each stored resource assigned to an available file service and a storage location on the hosting client device of the resource. Other examples are possible as well.

Although not shown, drive agent shim 40a may include other components as well. For example, drive agent shim 40a may include a working directory manager configured to provide one or more working directories on the hosting client device in which the example protocol can store resources. In another example, drive agent shim 40a may include a GUI configuration, which may take various forms depending on the operating system of the hosting client device. Other examples are possible as well.

Within the configuration depicted in FIG. 2, the example protocol may provide various addressing schemes for accessing resources and other information in LAN 12. For instance, the example protocol may provide a uniform resource identifier (URI) addressing scheme for accessing resources and other information. In this respect, the URIs may take various forms. For example, each such URI may begin with “/[ExampleProtocolID].” A URI for accessing a resource assigned to a given file service may then include “/FileServices/[ServiceType]/[ServiceName]/[ResourceID].” In some embodiments, this URI may additionally include “/[DeviceName]” before “/[ResourceID].” Further, a URI for accessing information stored in a data table may include “/Management/[TableName].” Other examples are possible as well.

### b. Example Provision of Applications

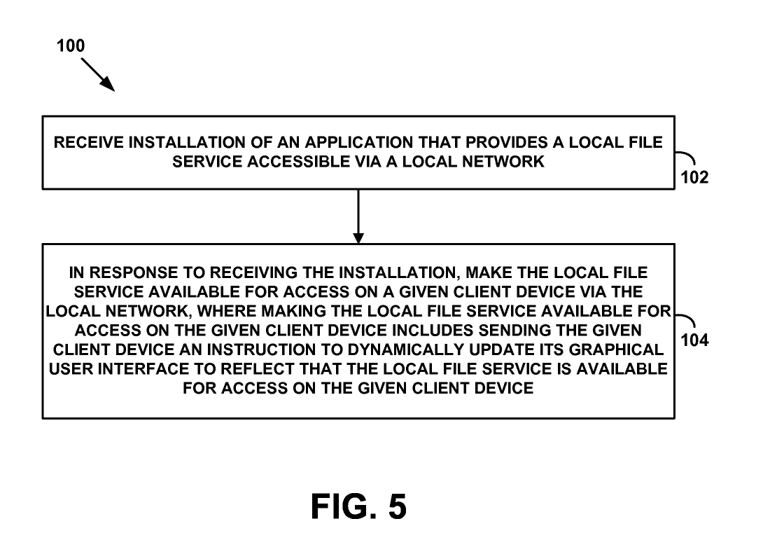

As described above, a networking device configured in accordance with the disclosed protocol may install, manage, and provide access to one or more applications, at least some of which may provide an interface between a local file service accessible via a local network and a remote file service accessible via a remote network. In doing so, the networking device enables client devices in the local network to access and use the functionality of these one or more applications without requiring the one or more applications to actually be installed on the client devices. FIG. 5 is a flow chart that depicts an example method 100 of carrying out these functions in accordance with the disclosed protocol. For purposes of illustration, example method 100 will be described with reference to networking device 14 being provisioned with a given application that provides an interface between a given local file service and a given remote file service, but it should be understood that example method 100 may be applicable to any computing device and any application operating according to the disclosed protocol.

Example method 100 may begin at step 102 with networking device 14 receives installation of the application that provides the given local file service accessible via LAN 12. When the application is installed, networking device 14 may store data associated with the application. For example, storage manager 30 may update application-service-resource table 82 to include a new application identifier, and access manager 28 may update service table 68 to include the given local file service (and other local file services, if any) associated with the application. Further, networking device 14 (e.g., storage manager 30) may update application-service-resource table 82 or a separate remote file service data table to include a remote file service identifier. In some scenarios, after the application has been installed, networking device 14 may prompt the user to provide login information for the application and/or provide settings/preferences associated with the application. The login information and settings/preferences may be modified by the user via the web interface associated with the application and accessible via web browser 46a.

After receiving the installation of the given application, networking device 14 may determine whether client device 16a and/or other client devices in LAN 12 are authorized to access the given local file service. Networking device 14 may perform this function in various manners. For example, networking device 14 may reference pre-stored authorization data stored at networking device 14, such as data stored in user table 64 and service table 68. The pre-stored authorization data may include, for example, an indication that client device 16a is operating in accordance with a local protocol account which permits client device 16a to access the given local file service. Alternatively, networking device 14 can query client device 16a in order to verify that client device 16a is operating as such. As another example, networking device 14 may receive authorization of client device 16a (and/or other client devices) by an administrative user via a web interface. Other examples are also possible.

At step 104, after receiving installation of the given application (and verifying that client device 16a is authorized to access the given local file service), networking device 14 may make the given local file service available for access on client device 16a (or one or more other given client devices of the one or more client devices, e.g., client devices 16a-c). Networking device 14 may carry out this feature in various manners. For example, networking device 14 may make the given local file service available for access on client device 16a by sending client device 16a one or more instructions to dynamically update a graphical user interface (GUI) (e.g., a context menu, tray icon, etc.) of client device 16a to reflect that the given local file service is available for access on client device 16a. The GUI may include context menus, tray icons, and/or other elements/menus that may be part of a GUI. An example update of the GUI when the application is first installed may include an addition of a menu item to the context menu that is associated with the application. Another example update of the GUI may include an addition of a tray icon to a taskbar, where the tray icon is associated with the application. Other examples are also possible.

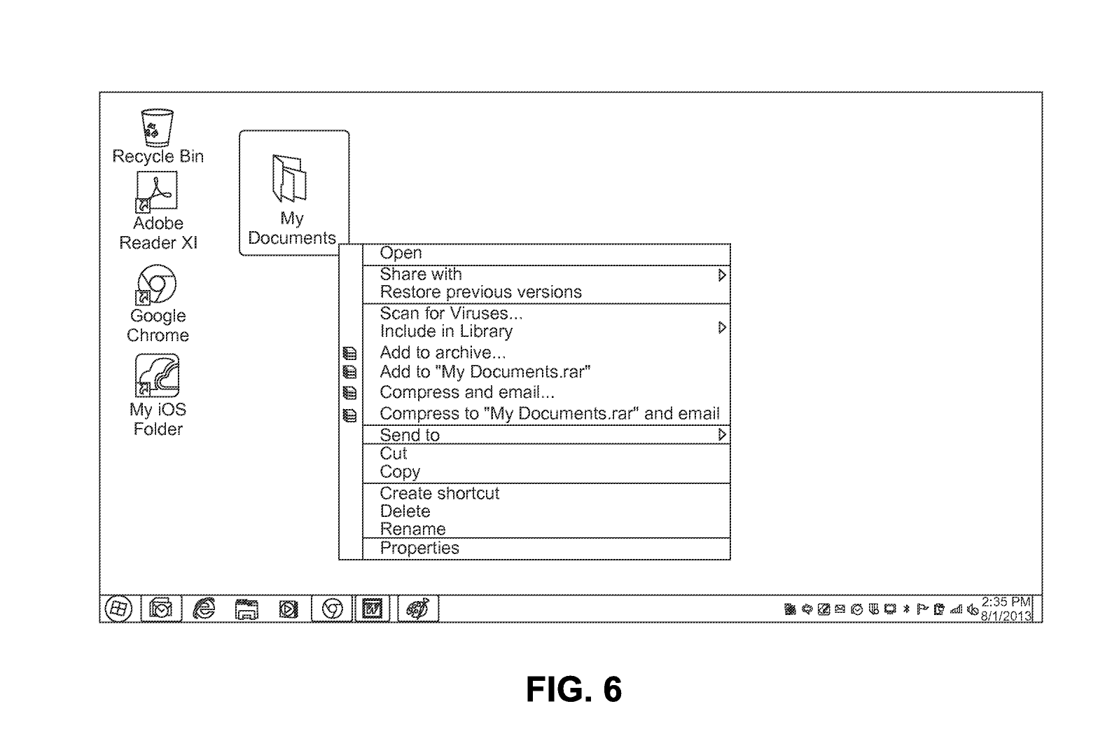

FIG. 6 depicts an example context menu for the “My Documents” directory at a time prior to client device 16a being configured according to the disclosed protocol. Thus, as shown, the example context menu does not display any local file service options for the “My Documents” directory, nor does it display an indication of an association between client device 16a and the disclosed protocol (e.g., “Homecloud,” as shown in the context menu of FIG. 7).

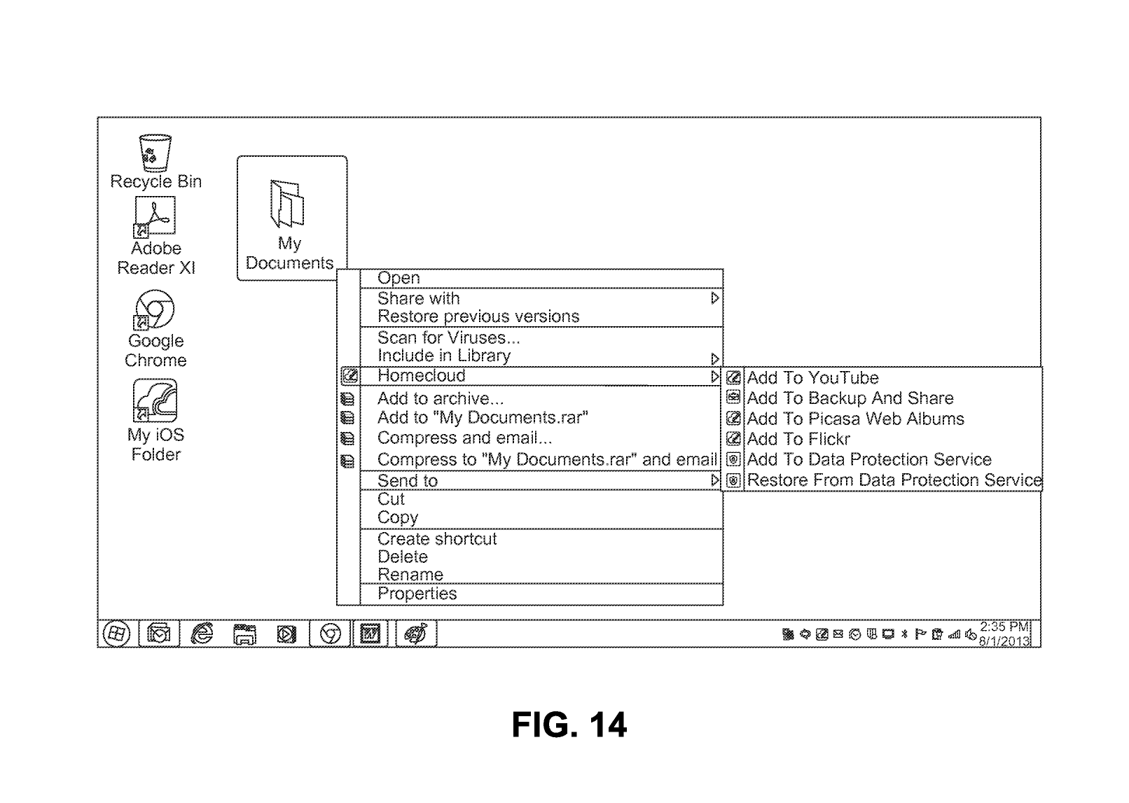

In turn, FIG. 7 depicts an example context menu for the “My Documents” directory at a time after client device 16a has been configured according to the disclosed protocol and networking device 14 has made a given local file service available to client device 14a. Thus, as shown, the example context menu displays a menu item associated with the disclosed protocol (e.g., “Homecloud”) that expands to show the actions that the user can request with respect to the local file service(s) available to client device 14. At the time depicted in FIG. 14, this includes the option to “add” the “My Documents” directory to the local file service entitled “Flickr.”

After the application has been installed and made available to client devices in LAN 12, networking device 14 may later receive an instruction to update a status of the application. In some embodiments, a user of client device 16a may manage the application and any other applications installed on networking device 14 via web browser 46a, which may communicate with web server 36 in order for the user to access a web interface for managing the application(s), as noted above. Via the web interface, the user may update the status of the application, and after doing so, client device 16a may send to networking device 14 the instruction to update the status of the application. The update may include, for example, an enabling of the application, a disabling of the application, and an uninstallation of the application from networking device 14, among other possibilities.

In response to receiving the instruction to from client device 16a, networking device 14 may provide instructions to client device 16a to dynamically update the GUI of client device 16a to reflect the updated status of the application. For example, if the update includes an disabling of the application, the instruction to dynamically update the GUI may include an instruction to remove one or more menu items from the context menu that are associated with the application. Alternatively, if the update includes an enabling of the application (or an initial installation of the application, as noted above), the instruction to dynamically update the GUI may include an instruction to add one or more menu items to the context menu that are associated with the application. Other examples are also possible.

Further, in response to receiving the instruction from client device 16a, networking device 14 may update stored data associated with the application to reflect the updated status of the application. For example, if the update includes an uninstallation of the application, networking device 14 may modify application-service-resource table 82 to reflect the uninstallation (i.e., remove some or all data associated with the application during uninstallation). Other examples are also possible.

Moreover, in some embodiments, the instructions to dynamically update the GUI of client device 16a may include instructions to provide for display on client device 16a a notification of the status of the application. For example, once the application is initially installed, client device 16a may provide for display a notification, such as a bubble notification or other type of notification, so as to alert the user of client device 16a that the installation has occurred. As another example, when the status of the application is changed, client device 16a may provide for display a notification so as to alert the user of the updated status of the application, such as a notification indicating that the application has been enabled, disabled, or uninstalled. Other examples are also possible.

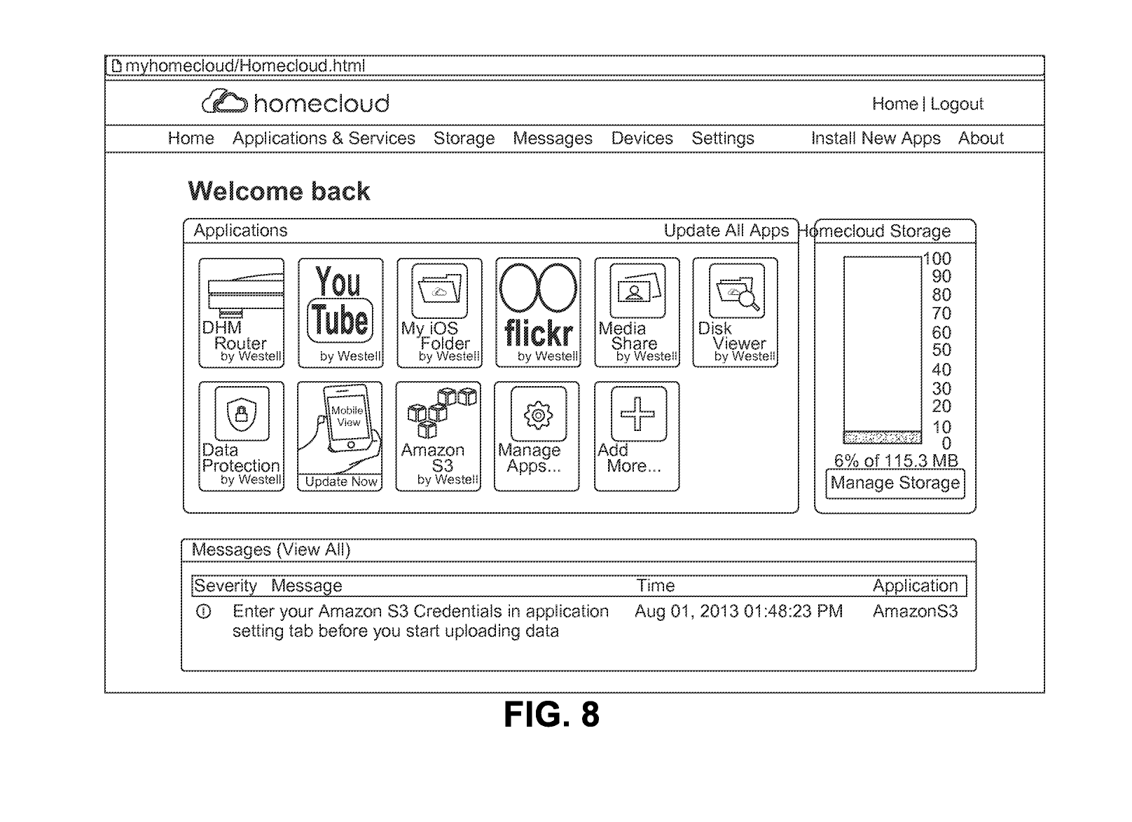

In line with the discussion above, FIGS. 8-12 is an example Internet-based user interface that comprises one or more webpages associated with installing and managing applications on networking device 14, in accordance with the example protocol. The Internet-based user interface may be accessed by a user of client device 16a via web browser 46a. For purposes of illustration, FIGS. 8-12 will be described with reference to networking device 14, client device 16a, and a user of both client device 16a and networking device 14, although it should be understood that other computing devices and users of such computing devices are also possible. It should also be understood that the webpages shown in FIGS. 8-12 may be linked with one another via various hyperlinks.

FIG. 8 is an example home screen webpage for networking device 14. As shown, this example home screen may include at its core a menu of applications installed on networking device 14. As noted above, each application may be provided by an individual or group that has access to a remote file service's API, and each application may provide a given local file service. Further, as shown, the example home screen webpage for networking device 14 may include other aspects as well, such as an indicator of storage space of networking device 14 and a list of messages/notifications related to the functions performed by networking device 14 (e.g., a change of status of a particular application, a change in relationship between a given resource and a given local file service, a change in a remote file service, etc).

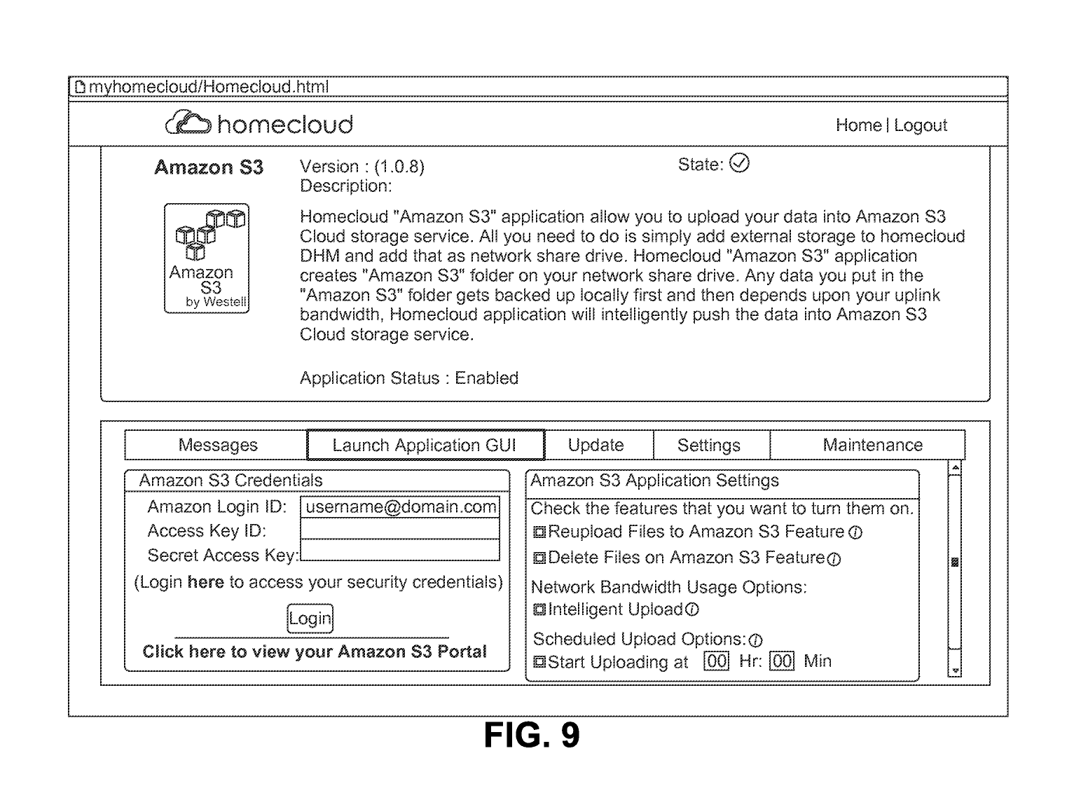

In turn, FIG. 9 is a webpage associated with a particular application that was listed in the applications menu of shown in FIG. 8. As shown, the webpage associated with the particular application (and each respective webpage of the other applications installed on networking device 14) may include a “Messages” tab, an “Update” tab, and a “Settings” tab, among other possibilities. The “Messages” tab, for instance, may provide a message/notification history associated with the particular application. The “Update” tab may enable the user to search for and install updates to the particular application. The “Settings” tab may enable the user to modify features of the particular application and provide credentials (e.g., login information) associated with the particular application. The webpage may enable the user to perform other functions as well.

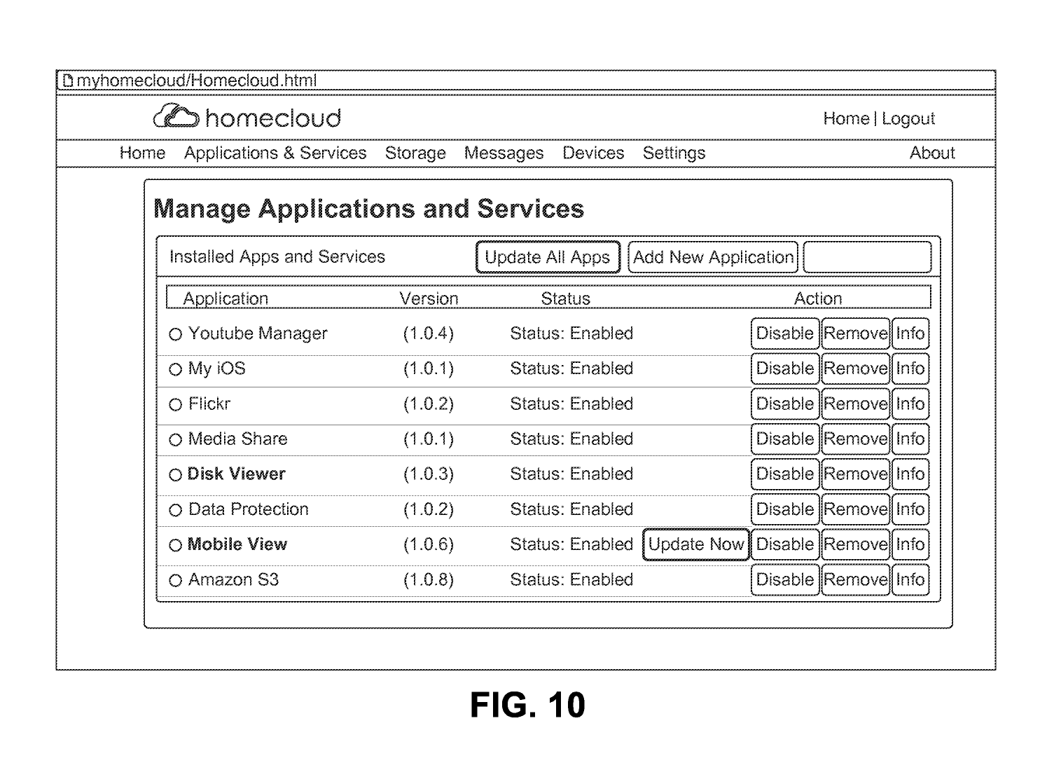

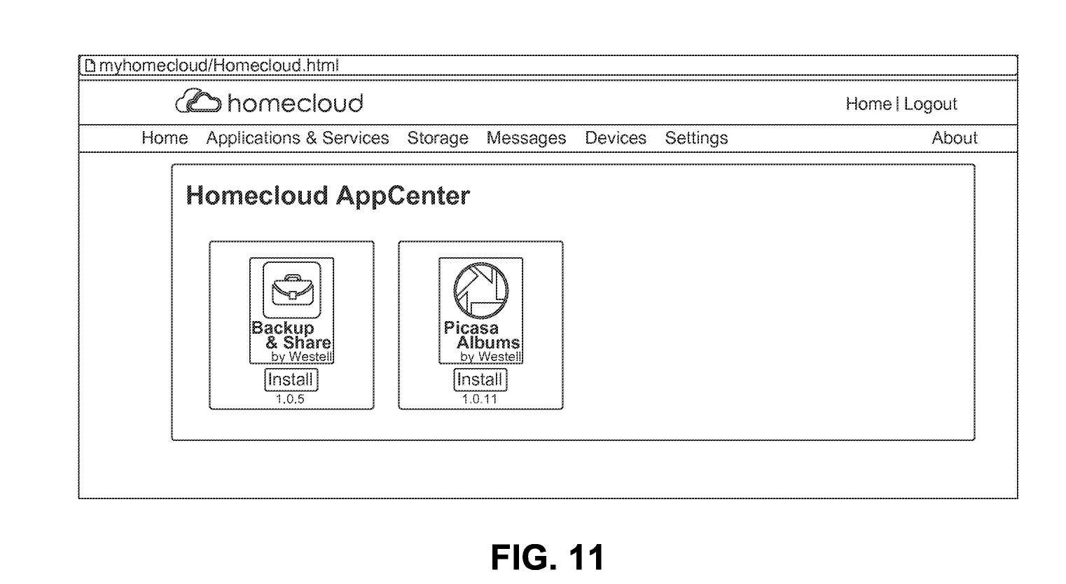

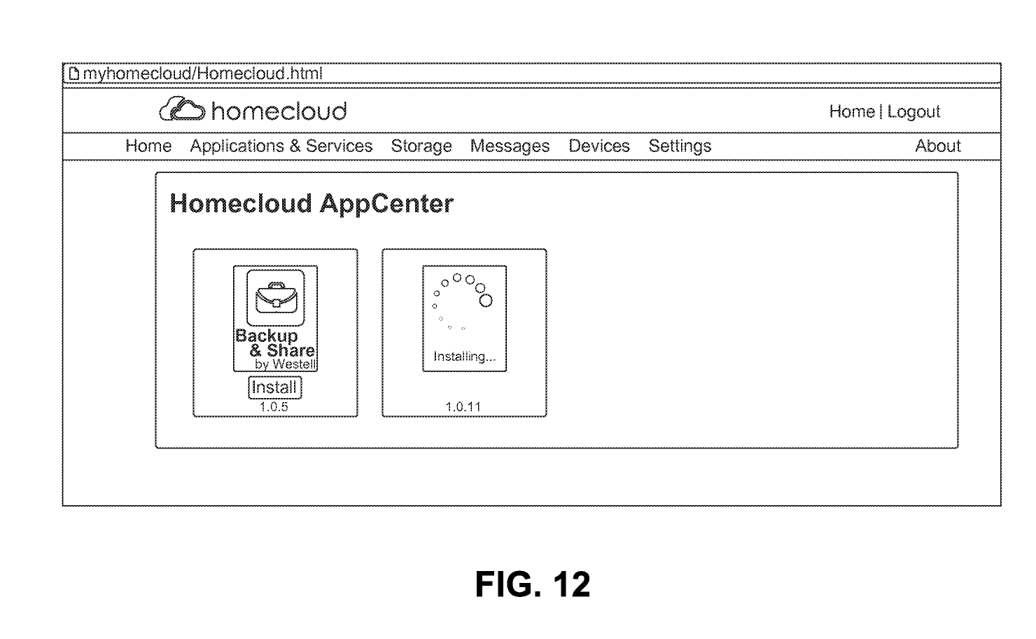

FIG. 10 is a webpage that enables the user to manage the applications installed on networking device 14. For example, as shown, the webpage may enable a user to update, enable/disable, or remove (i.e., uninstall) each application installed on networking device 14. Additionally, the webpage may enable a user to view other information associated with the particular application. Additionally yet, the webpage may enable a user to navigate to a webpage that facilitates the installation of a new application on networking device 14, such as the webpage depicted in FIGS. 11-12. The webpage may enable the user to perform other functions as well.

### c. Example Resource Assignment and Interface Between File Services

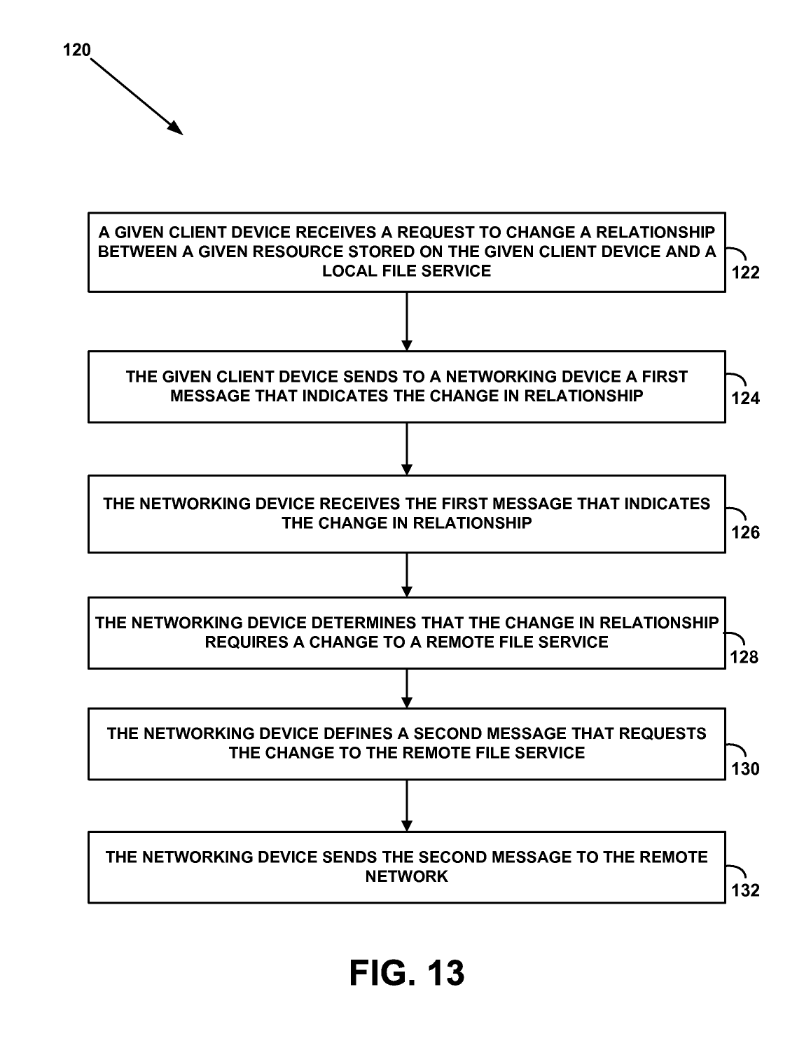

As described above, certain applications installed on a networking device configured according to the disclosed protocol may provide an interface between a local file service and a the remote file service, which may enable client devices in a local network to seamlessly manage resources on the remote file service. FIG. 13 is a flow chart depicting an example method 120 of carrying out these functions in accordance with the disclosed protocol. For purposes of illustration, example method 120 will also be described with reference to networking device 14 hosting a given application that provides an interface between a given local file service and a given remote file service, but it should be understood that example method 120 may be applicable to any computing device or application operating according to the example protocol.

At step 122, once the given local file service is available for access on client device 16a, client device 16a may receive a request from a user to change a relationship between a given resource (or multiple resources) stored on client device 16a and the given local file service. This change in relationship may take various forms, examples of which include assignment of the given resource to the given local file service, removal of the given resource from the given local file service, and updating of the given resource that has been assigned to the given local file service.

The user's request to change the relationship between the given resource (or resources) and the local file service may also take various forms. In one embodiment, for instance, the request may take the form of the user opening a context menu for the given resource (e.g., by right clicking on the icon representing the resource), which may be configured to display file service options for the given resource, and the user then selecting the given local file service in the context menu. As noted above, the GUI may also include tray icons and/or other elements/menus that can be used to request to change the relationship between the given resource and the local file service. Other examples are possible as well.

Once the user's request to change the relationship between the given resource and the local file service has been received, the GUI may change an overlay icon or badge icon proximate to an icon representative of the given resource. This change in the overlay or badge icon can be displayed in various ways. For example, once the given resource has been selected to be added to the local file service, the overlay or badge icon may indicate that the given resource is in the process of being added to the local file service. Then, once the given resource has successfully been added to the local file service, the overlay or badge icon may indicate that the given resource was successfully added. On the other hand, if the addition of the given resource to the local file service fails, the overlay or badge icon may indicate the failure. An overlay or badge icon that indicates a successful addition may include an icon representative of the local file service or the application that provides the local file service. As another example, if the given resource is removed from the local file service, an existing overlay or badge icon proximate to the given resource's icon may indicate that the given resource is in the process of being removed from the local file service, and may then indicate that the given resource has been successfully or unsuccessfully removed from the local file service. As yet another example, when the given resource is a file directory that includes one or more files, icons associated with each respective file may include a respective overlay or badge icon that can be changed based on the change in relationship between the file directory and the local file service. Other examples are also possible.

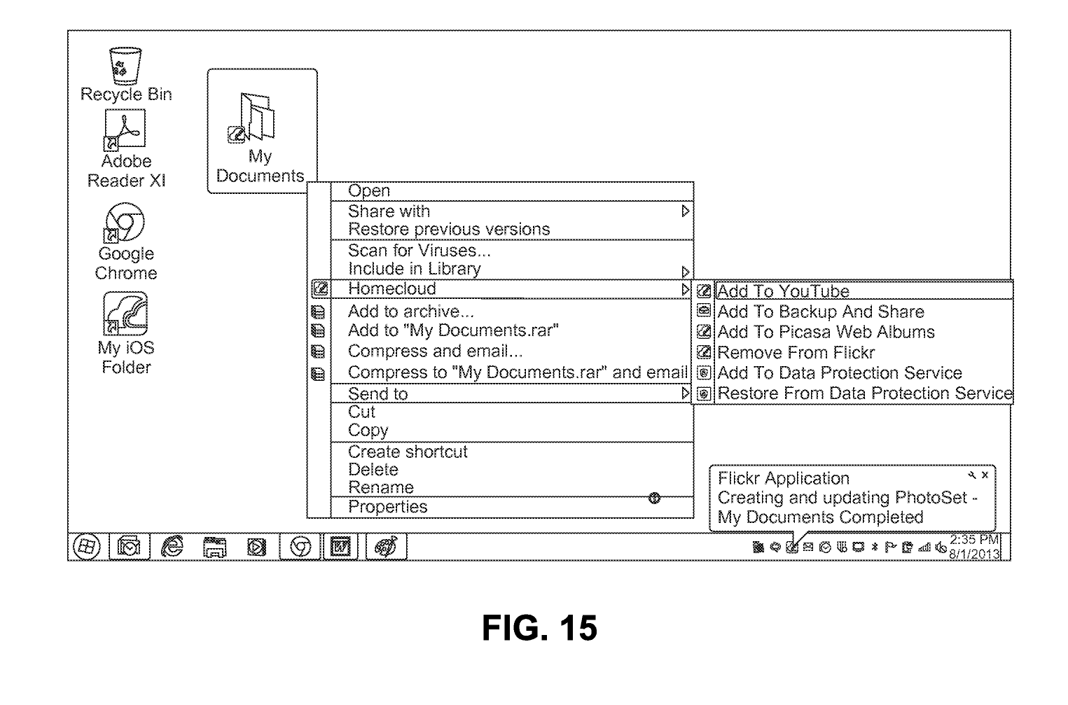

In line with this discussion, FIGS. 14 and 15 are screenshots that show an example graphical user interface (GUI) for client device 16a and illustrate a user's options for changing a relationship between the client device's “My Documents” folder and various local file services, in accordance with the example protocol.

Specifically, FIG. 14 depicts an example context menu for the “My Documents” directory at a time after networking device 14 has made various local file services available to client device 16a. As shown, a user may access these local file services by opening a context menu for the “My Documents” directory stored on client device 14a and navigating to the menu item associated with the “Homecloud” protocol, which will display the options that the user has with respect to the local file services. In the example depicted in FIG. 15, the user is provided the option to “add” the “My Documents” directory to YouTube®, “add” the directory to Picasa® Web Albums, “add” the directory to Flickr®, among other options.

In turn, FIG. 15 depicts an example context menu for the “My Documents” directory at a time after client device 16a has assigned the “My Documents” directory to the Flickr® local file service. As shown, this assignment has caused client device 16a to change the context menu such that the user is now given the option to “remove” the “My Documents” directory from the Flickr® local file service. Further, as shown, this assignment may cause also client device 16a to display a bubble notification that the “My Documents” directory has successfully been added to the local file service. Still further, as shown, the “My Documents” directory includes an overlay or badge icon that indicates that the directory is associated with a given local file service provided by the “Homecloud” protocol.

Referring back to FIG. 13, in response to receiving the user's request to change the relationship between the given resource and the given local file service, client device 16a may update its own internal data table, such as a resource-location table or other table, to reflect the change in relationship. Further, client device 16a may generate a unique identifier of the given resource that correlates to a storage location of the given resource on client device 16a and store that unique identifier. The unique identifier may take various forms. In one example, the unique identifier may take the form of numerical string, and other examples are also possible. Client device 16a may also store the unique identifier of the given resource together with an identifier of the given resource's storage location (e.g., in the resource-location table noted above). The storage location identifier may also take various forms. In one example, the storage location identifier may be a file path. Other examples are possible as well.

At step 124, client device 16a may send to networking device 14 a first message that indicates the change in relationship. The first message may take various forms. As one example, the message may include the unique identifier of the given resource, an identifier of the local file service (e.g., an alphanumerical code or text string), and an indicator of the change in relationship (e.g., an alphanumerical code or text string). In some scenarios, the message may additionally include a copy of the given resource. Other examples are possible as well.

At step 126, networking device 14 may then receive, from client device 16a, the first message that indicates the change in relationship between the given resource stored on client device 16a and the local file service. Upon receiving the first message that indicates the change, networking device 14 may update application-service-resource table 82 (or other data storage) to reflect the change in relationship. In practice, this update may comprise adding a client device identifier paired with an identifier of the given resource to application-service-resource table 82 to correlate with an application identifier and a local file service identifier that is currently stored in the table. In some scenarios, the update may also comprise removing or modifying any of the identifiers noted above. Other scenarios are also possible.

Networking device 14 may also receive, either with the first message or sometime after receiving the first message, at least one copy of the given resource, and may then store that copy of the given resource in application-service-resource table 82 or in some other data storage either coupled to networking device 14 or elsewhere in LAN 12.

At step 128, after receiving the first message, networking device 14 may then determine that the indicated change in relationship between the given resource and the given local file service requires a change to the given remote file service. For example, when the change in relationship between the given resource and the local file service takes the form of an assignment/addition of the given resource to the local file service, networking device 14 may determine that the remote file service must be changed to add the given resource to the remote file service. As another example, the change in relationship may be a removal of the given resource from the local file service, and networking device 14 may determine that the remote file service must be changed to remove the given resource from the remote file service. As yet another example, when the given resource is already associated with the local file service and change in relationship between the given resource and the local file service takes the form of an update of the given resource, such as a file name change to the given resource, networking device 14 may determine that the given resource must be updated accordingly in the remote file service if the given resource has already been added to the remote file service. However, in other examples, a change to the remote file service may not be required.

At step 130, in response to determining that a change to the remote file service is required, networking device 14 may define a second message that requests the change to the remote file service. The requested change to the remote file service may reflect the change in relationship between the given resource and the local file service. For example, in line with the changes in relationship between the given resource and the given local file service discussed above, networking device 14 may define a message that requests an addition of the given resource to the remote file service, a removal of the given resource from the remote file service, and/or an update to the given resource in the remote file service. Other examples are also possible.

At step 132, networking device 14 may send to WAN 18 the second message that requests the change to the remote file service. More specifically, networking device 14 may send the message to server 20 in WAN 18 or another remote network, and server 20 may be configured to receive the second message, manage resources associated with the remote file service, and possibly send a response message to networking device 14.

In some embodiments, networking device 14 may also send, either with the second message or sometime after sending the second message, at least one copy of the given resource that is the subject of the change in relationship. For example, when the change in relationship comprises a file/directory being newly assigned to the given local file service or a file being address to a directory that is already assigned to the given local file service, networking device 14 will send a copy of the file/directory to server 20 (or another computing device in WAN 18 that is associated with the remote file service). Networking device 14 may carry out the feature of sending the at least one copy of the given resource in various manners. According to some implementations, networking device 14 may already have a copy of the given resource stored in data storage at the time it defines the second message (e.g., if client device 16a sends the given resource with the first message), in which case networking device 14 may simply retrieve the copy of the given resource from data storage and send it to server 20. According to other implementations, networking device 14 may not have the copy of the given resource stored in data storage at the time it defines the second message, in which case networking device 14 may need to retrieve a copy of the given resource from client device 16a before sending it to server 20. Other scenarios are also possible.

Networking device 14 may send the second message (and possibly the given resource, in some scenarios) at various times. For example, networking device 14 may send the second message immediately after defining the second message. As another example, networking device 14 may send the second message at a time that is determined based on the bandwidth of the communication link to WAN 18. This can be implemented in various ways. In one implementation, networking device 14 may wait until the bandwidth reaches a particular threshold, or may wait until a timer expires.

It should be understood that in scenarios in which the second message and the given resource are both sent, they may be sent at different times. For example, the given resource may be sent after the second message and at a time when the bandwidth allows for the given resource to be sent, since the given resource may require much more bandwidth than the second message.

In some embodiments, networking device 14 may also be configured receive, via WAN 18, a message indicating a change to the remote file service that was not requested by networking device 14. In response, networking device 14 may determine whether the change to the remote file service requires a corresponding change to the local file service, and if so, may update the local file service to reflect the change. Networking device 14 may facilitate this update in various manners. For example, networking device 14 may send a message indicating the change (along with a given resource, in some scenarios) to client device 16a, which may then update its resources accordingly. That message (and the given resource) may be sent in a similar manner as other messages and resources are communicated according to the disclosed protocol.

As an example scenario, a file directory stored on client device 16a may be added by the user of client device 16a to the local file service and then added by networking device 14 to the remote file service. In this scenario, the remote file service and the file directory may accessible on client device 16a using web browser 46a via WAN 18 (e.g., via a website associated with the remote file service). As such, the user of client device 16a may add another resource (or resources) to the file directory using web browser 46a, thereby adding that resource to the local and remote file services. For example, if the remote file service is an Internet-based image hosting file service, the file directory may be a directory of the user's image files that the user has uploaded to the remote file service. The user may then use a different client device to add another image file that is stored on the different client device (and not on client device 16a) to the file directory, such as an image file that the user views as part of another file directory that is not the user's. If the local file service is a file sync service, once the other resource (e.g., the other image file) is added, that resource may be automatically downloaded to client device 16a (e.g., received by networking device 14 via WAN 18 and forwarded to client device 16a) and stored in the file directory. On the other hand, if the local file service is a file share service, the added resource may not be downloaded to client device 16a unless the file directory is assigned to a file sync service as well as the file share service. Other scenarios are possible as well.

As another example scenario, a given resource stored on client device 16a may be assigned to the local file service, and the local file service may be a file search service. As such, an application hosted by networking device 14 that provides an interface between the file search service and a remote file service may add the given resource to the remote file service and enable other computing devices in LAN 12 or computing devices in remote networks such as WAN 18 to search for the given resource or any other resources that are assigned to the file search service. Other scenarios are also possible.

### d. Example Resource Access

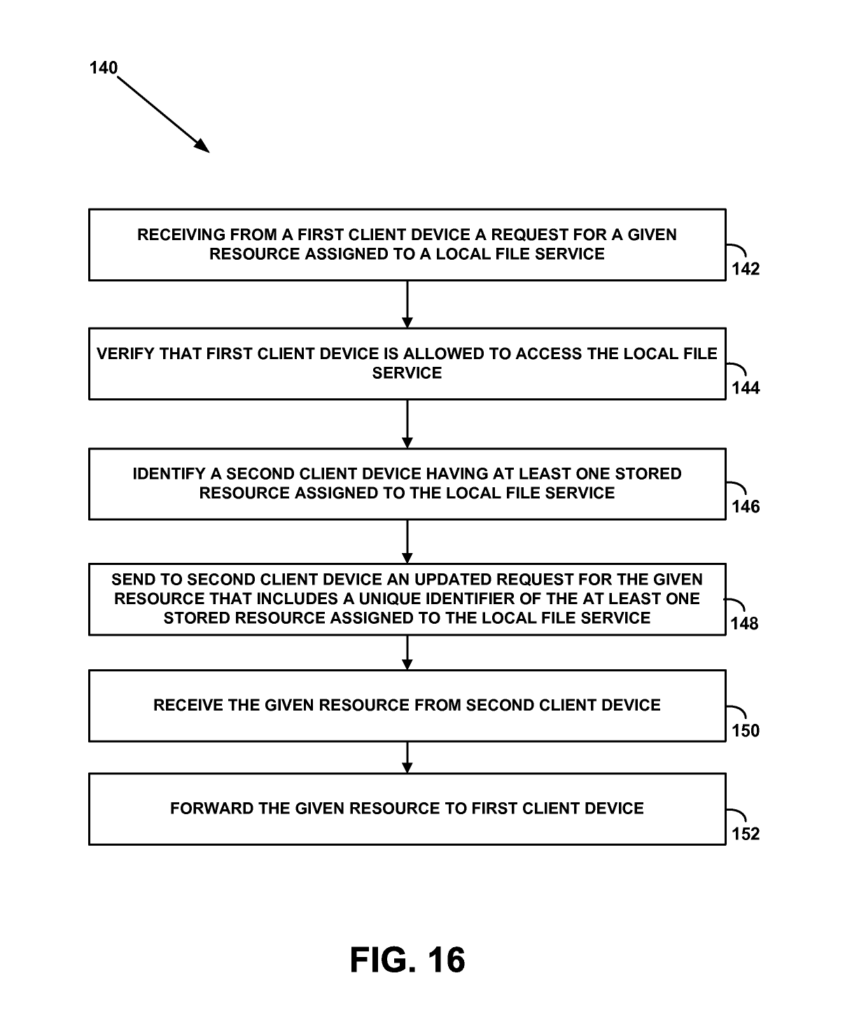

As discussed above, networking device 14 may host applications that facilitate resource sharing between two or more client devices in LAN 12, in accordance with the disclosed protocol. Accordingly, FIG. 16 is a flow chart depicting an example method 140 for implementing this. For purposes of illustration, example method 140 will be described with reference to networking device 14 (e.g., access manager 28 and storage manager 30 installed on networking device 14) facilitating access to a resource associated with the local file service, but it should be understood that example method 140 may be applicable to any computing device(s) operating according to the example protocol. For example, example method 140 may be applicable to server 20 or another entity of WAN 18 accessing resources stored on computing device in LAN 12, including networking device 14. Further, in line with the discussion above with respect to exemplary methods 100 and 120, example method 140 may be applicable to networking device 14 accessing resources stored on client devices in LAN 12. Other examples are also possible.

Example method 140 may begin with client device 16b sending to networking device 14 a request for a given resource (e.g., a file, directory, and/or metadata) associated with a local file service, such as a file share, a file sync, or a file search service for instance. For instance, a native application installed on client device 14b may initiate such a request, and a drive agent shim installed on client device 14b may then be configured to detect the initiation of the request and responsively send the request to networking device 14. Other examples are possible as well.

At step 142, networking device 14 (e.g., access manager 28) may then receive the request from client device 16b. This request may include an identifier of the given resource and an identifier of the local file service. Further, in some embodiments, the request may include an identifier of another of client devices 16a-c from which to obtain the given resource. The request itself may take various forms. In one example, the request may include a URI as described above. Other examples are possible as well.

At step 144, in response to receiving the request, networking device 14 (e.g., access manager 28) may verify that client device 16b is allowed to access the local file service. For instance, networking device 14 may first identify a user associated with client device 16b (e.g., based on user table 64 described above). In turn, networking device 14 may determine that the identified user is allowed to access the local file service based on a table mapping file services to identifiers of users allowed to access the file services (e.g., service table 68 described above). Other examples are possible as well.

At step 146, in response to verifying that client device 16a is allowed to access the local file service, networking device 14 (e.g., storage manager 30) may identify a second one of client devices 16a-c having at least one stored resource assigned to the local file service. Networking device 14 may perform this identification in various manners. In one example, if the request for the given resource includes an identifier of another of client devices 16a-c from which to obtain the given resource, networking device 14 may identify that client device. In another example, networking device 14 may identify the other of client devices 16a-c based on a table mapping file services to client devices having at least one resource assigned to the file services (e.g., service table 68 described above). In this respect, if networking device 14 identifies two or more clients having at least one resource assigned to the local file service, networking device 14 may employ load balancing to select one of these client devices. Other examples are possible as well.

At step 148, networking device 14 (e.g., storage manager 30) may then send to the second one of client devices 16a-c, such as client device 16a, an updated request for the given resource. This updated request may include a unique identifier of the at least one stored resource assigned to the local file service. The updated request may include other information as well.

As a result of networking device 14 sending the updated request, client device 16a may receive the updated request. In turn, client device 16a may locate the given resource in storage based on a correlation of the unique identifier of the at least one stored resource to a storage location of the at least one stored resource (e.g., the resource-location table described above). For example, if the given resource is a file and the at least one stored resource is a directory, client device 16a may first locate the stored directory based on the correlation of the unique identifier of the stored directory to the storage location of the stored directory. Client device 16a may then locate the file within the stored directory. Other examples are possible as well. After locating the given resource, client device 16a may then send the given resource for receipt by client device 16b.

At step 140, networking device 14 may receive the given resource from client device 16a. In turn, at step 142, networking device 14 may forward the given resource to client device 16b.

### e. Additional Services

The example protocol described herein may also provide various other services. For example, the example protocol may be configured to provide a unified desktop through which a user can launch applications and interact with widgets. As another example, the example protocol may further be configured to enable access to data on an information appliance in LAN 12. Other examples are possible as well.

### III. Conclusion

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

I claim:

1. A method, comprising:
in a networking device coupled to one or more client devices in a local network, hosting an application that provides an interface between a first file service accessible via the local network and a second file service accessible via a remote network;
the networking device making the first file service available for access on a given client device of the one or more client devices via the local network;
the networking device receiving, from the given client device, a first message that indicates a change in a relationship between a given resource stored on the given client device and the first file service;
after receiving the first message, the networking device determining that the change in the relationship between the given resource and the first file service requires a change to the second file service;
in response to the determining, the networking device defining a second message that requests the change to the second file service; and
the networking device sending the second message to the remote network.

2. The method of claim 1, wherein the given resource comprises a file or a file directory.

3. The method of claim 1, wherein making the first file service available for access on the given client device comprises:
sending the given client device an instruction to dynamically update its graphical user interface to reflect that the first file service is available for access on the given client device.

4. The method of claim 3, wherein the graphical user interface includes a context menu.

5. The method of claim 1, wherein the first file service comprises one or more of a file share service, a file sync service, and a file search service.

6. The method of claim 1, wherein the remote network is the Internet.

7. The method of claim 6, wherein the second file service is a web service accessible via the Internet.

8. The method of claim 1, wherein the second message includes a message that requests an addition of the given resource to the second file service.

9. The method of claim 8, further comprising:
the networking device sending to the given client device a request to access the given resource;
in response to the sending, the networking device receiving the given resource; and
the networking device sending the given resource to the remote network.

10. The method of claim 1, wherein the second message includes a message that requests a removal of the given resource from the second file service.

11. The method of claim 1, wherein the second message includes a message that requests an update to the given resource in the second file service.

12. The method of claim 1, further comprising:
the networking device storing data reflecting the change in the relationship between the given resource and the first file service.

13. The method of claim 1, wherein the networking device comprises one or more of a switch, a bridge, a router, and a gateway.

14. The method of claim 1, wherein the networking device sending the second message to the remote network comprises:
the networking device assessing a bandwidth of a connection to the remote network; and
based on the assessed bandwidth, the networking device determining a time at which to send the second message.

15. The method of claim 1, further comprising:
the networking device receiving, via the remote network, a message indicating a change to the second file service; and
in response to receiving the message indicating the change to the second file service, the networking device updating the first file service to reflect the change to the second file service.

16. The method of claim 1, further comprising:
sending the given client device an instruction to dynamically update its graphical user interface to reflect the change in the relationship between the given resource and the first file service.

17. A method, comprising:
in a networking device coupled to one or more client devices in a local network, receiving installation of an application that provides access to one or more file services; and
after receiving the installation, the networking device making the one or more file services available for access on a given client device of the one or more client devices without requiring the given client device to separately install an application that provides access to the one or more file services.

18. The method of claim 17, wherein the networking device making the one or more file services available for access on the given client device comprises:
sending the given client device an instruction to dynamically update its graphical user interface to reflect that the one or more file services are available for access on the given client device.

19. The method of claim 18, further comprising:
the networking device receiving an instruction to update a status of the application; and
in response to receiving the instruction, the networking device providing instructions to the given client device to dynamically update the graphical user interface of the given client device to reflect the updated status of the application,
wherein the update to the status of the application comprises one of: an enabling of the application, a disabling of the application, and an uninstallation of the application from the networking device.

20. The method of claim 19, further comprising:
in response to receiving the installation, the networking device storing data associated with the application; and
in response to receiving the instruction to update the status of the application, the networking device updating the stored data to reflect the updated status of the application.

21. The method of claim 19, wherein the instructions to dynamically update the graphical user interface of the given client device to reflect the updated status of the application include instructions to provide for display on the given client device a notification of the updated status of the application.

22. The method of claim 21, wherein the notification is a bubble notification.

23. The method of claim 18, wherein dynamically updating the graphical user interface comprises dynamically updating one or more of a context menu of the graphical user interface and a tray icon of the graphical user interface.

24. The method of claim 17, wherein the networking device making the one or more file services available for access on the given client device comprises allowing the given client device to assign one or more resources stored on the given client device to at least one of the one or more file services.

25. The method of claim 17, wherein the one or more file services comprises a first file service accessible via the local network.

26. The method of claim 25, wherein the first file service comprises one or more of a file share service, a file sync service, and a file search service.

27. The method of claim 25, wherein the one or more file services further comprises a second file service accessible via the remote network, and wherein the application makes the second file service available for access on the given client device by providing an interface between the first file service and the second file service.

28. The method of claim 27, wherein the second file service is a web service accessible via the Internet.

29. A networking device comprising:
a communication interface configured to interface with one or more client devices in a local network and further configured to interface with a remote network; and
a processor configured to:
enable the networking device to host an application that provides an interface between a first file service accessible via the local network and a second file service accessible via the remote network;
enable the networking device to make the first file service available for access on a given client device of the one or more client devices via the local network;
enable the networking device to receive, from the given client device, a first message that indicates a change in a relationship between a given resource stored on the given client device and the first file service;
enable the networking device to determine, after receiving the first message, that the change in the relationship between the given resource and the first file service requires a change to the second file service;
enable the networking device to define, in response to the determining, a second message that requests the change to the second file service; and
enable the networking device to send the second message to the remote network.

30. The networking device of claim 25, wherein the second message includes a message that requests an addition of the given resource to the second file service, the processor being further configured to:
enable the networking device to send to the given client device a request to access the given resource;
in response to the sending, enable the networking device to receive the given resource;
enable the networking device to determine a bandwidth limit of a connection between the networking device and the remote network; and
based on the determined bandwidth limit, enabling the networking device to determine a time at which to send the given resource to the remote network.

31. The networking device of claim 25, wherein the first file service is at least a file sync service, and wherein the given resource is a file directory, the processor being further configured to:
enable the networking device to receive, via the remote network, a message that defines an addition of a new resource to the file directory;
enable the networking device to thereafter receive, from the remote network, the new resource; and
in response to receiving the new resource, enable the networking device to send the new resource to the given client device.

32. A non-transitory computer readable medium having instructions stored thereon, the instructions comprising:
instructions for enabling the networking device to host an application that provides an interface between a first file service accessible via the local network and a second file service accessible via the remote network;
instructions for enabling the networking device to make the first file service available for access on a given client device of the one or more client devices via the local network;
instructions for enabling the networking device to receive, from the given client device, a first message that indicates a change in a relationship between a given resource stored on the given client device and the first file service;
instructions for enabling the networking device to determine, after receiving the first message, that the change in the relationship between the given resource and the first file service requires a change to the second file service;
instructions for enabling the networking device to define, in response to the determining, a second message that requests the change to the second file service; and
instructions for enabling the networking device to send the second message to the remote network.
